(19) United States
(12) Patent Application Publication
(10) Pub. No.: US 2026/0014708 A1
(43) Pub. Date: Jan. 15, 2026

(54) METHOD AND SYSTEM FOR PERFORMING HIERARCHICAL IMITATION LEARNING TO TRAIN A ROBOT TO PERFORM A TASK

(71) Applicants: Toyota Research Institute, Inc., Los Altos, CA (US); The Trustees of Princeton University, Princeton, NJ (US); The Regents of the University of California, Oakland, CA (US)

(72) Inventors: Kyle Hatch, Los Altos, CA (US); Ashwin Balakrishna, Los Altos, CA (US); Suraj Nair, San Francisco, CA (US); Blake Wulfe, Los Altos, CA (US); Mikhal Itkina, Los Altos, CA (US); Thomas Kollar, Los Altos, CA (US); Benjamin Burchfiel, Los Altos, CA (US); Benjamin Eysenbach, Princeton, NJ (US); Oier Mees, Oakland, CA (US); Seohong Park, Oakland, CA (US); Sergey Levine, Oakland, CA (US)

(73) Assignees: Toyota Research Institute, Inc., Los Altos, CA (US); Toyota Jidosha Kabushiki Kaisha, Toyota-shi Aichi-ken (JP); The Trustees of Princeton University, Princeton, NJ (US); The Regents of the University of California, Oakland, CA (US)

(21) Appl. No.: 19/206,460

(22) Filed: May 13, 2025

Related U.S. Application Data
(60) Provisional application No. 63/671,517, filed on Jul. 15, 2024.

(51) Int. Cl. B25J 9/16

(52) U.S. Cl. CPC B25J 9/1697; B25J 9/1658; B25J 9/1661

(57) ABSTRACT

A method may include receiving an image of a robot, receiving a language instruction of a task to be performed by the robot, generating a plurality of image sequences of the robot performing the task based on the received image of the robot and the language instruction, selecting a first image sequence among the plurality of image sequences having a highest probability of performing the task, and determining a plurality of actions to be performed by a second robot to perform the task based on the first image sequence.

### CROSS-REFERENCE TO RELATED APPLICATION

The present specification is based on, and claims priority from U.S. Provisional Application No. 63/671,517, filed Jul. 15, 2024, the disclosure of which is hereby incorporated by reference in its entirety.

### TECHNICAL FIELD

The present specification relates to robot learning, and more particularly to a method and system for performing hierarchical imitation learning to train a robot to perform a task.

### BACKGROUND

One method of training a robot to perform tasks is to provide a series of images to a model showing a robot progressing from an initial state to a goal state while performing the task. The model may then determine a series of actions for the robot to perform to transition from the initial state to the goal state. As such, the model may implement hierarchical imitation learning to learn to perform a complex task by imitating the actions performed in the training data.

One way of generating training data to be used for hierarchical imitation learning is to use a generative model, such as a diffusion model, to generate images of a robot performing a task. In particular, an image of an initial state of a robot may be provided to the generative model along with a prompt indicating a task to be performed by the robot. The generative model may then generate a series of images of the robot performing the task based on the initial image. These generated images may then be used to train a robot to perform the specified task by imitating the actions in the generated images.

The above described techniques can be broken down into a high-level policy of generating images of a robot performing a task, and a low-level policy of generating a series of control commands to cause a robot to imitate the generated images of the robot performing the task. The images of the robot performing intermediate steps of the task may be considered subgoals to be performed by the robot during the course of performing the task.

However, some of the generated subgoals may not actually make progress towards completing the task, even if they are likely to occur at some point when the task is performed. Furthermore, even if the generated subgoals lead to task progress, they may contain hallucinated artifacts which make them unsuitable for control. Accordingly, a need exists for a method and system for performing hierarchical imitation learning to train a robot to perform a task.

### SUMMARY

In one embodiment, a method may include receiving an image of a robot, receiving a language instruction of a task to be performed by the robot, generating a plurality of image sequences of the robot performing the task based on the received image of the robot and the language instruction, selecting a first image sequence among the plurality of image sequences having a highest probability of performing the task, and determining a plurality of actions to be performed by a second robot to perform the task based on the first image sequence.

In another embodiment, a computing device may comprise one or more processors configured to receive an image of a robot, receive a language instruction of a task to be performed by the robot, generate a plurality of image sequences of the robot performing the task based on the received image of the robot and the language instruction, select a first image sequence among the plurality of image sequences having a highest probability of performing the task, and determine a plurality of actions to be performed by a second robot to perform the task based on the first image sequence.

### BRIEF DESCRIPTION OF THE DRAWINGS

The embodiments set forth in the drawings are illustrative and exemplary in nature and are not intended to limit the disclosure. The following detailed description of the illustrative embodiments can be understood when read in conjunction with the following drawings, where like structure is indicated with like reference numerals and in which:

FIG. 1 schematically depicts a computing device for performing hierarchical imitation learning to train a robot to perform a task, according to one or more embodiments shown and described herein;

FIG. 2A shows an image of a robot in an example scene, according to one or more embodiments shown and described herein;

FIG. 2B shows an image of a robot in another example scene, according to one or more embodiments shown and described herein;

FIG. 2C shows an image of a robot in another example scene, according to one or more embodiments shown and described herein;

FIG. 2D shows an image of a robot in another example scene, according to one or more embodiments shown and described herein;

FIG. 3A shows an example image that may be generated by the computing device of FIG. 1, according to one or more embodiments shown and described herein;

FIG. 3B shows another example image that may be generated by the computing device of FIG. 1, according to one or more embodiments shown and described herein;

FIG. 3C shows an example image that may be generated by the computing device of FIG. 1, according to one or more embodiments shown and described herein;

FIG. 3D shows an example image that may be generated by the computing device of FIG. 1, according to one or more embodiments shown and described herein;

FIG. 4A shows an example image that may be generated by the computing device of FIG. 1, according to one or more embodiments shown and described herein;

FIG. 4B shows another example image that may be generated by the computing device of FIG. 1, according to one or more embodiments shown and described herein;

FIG. 4C shows an example image that may be generated by the computing device of FIG. 1, according to one or more embodiments shown and described herein;

FIG. 4D shows an example image that may be generated by the computing device of FIG. 1, according to one or more embodiments shown and described herein;

FIG. 5 depicts a flowchart of a method for operating the computing device of FIG. 1, according to one or more embodiments shown and described herein; and

FIG. 6 shows an example method for training the classifier maintained by the computing device of FIG. 1, according to one or more embodiments shown and described herein.

### DETAILED DESCRIPTION

In embodiments disclosed herein, a method and system for performing hierarchical imitation learning to train a robot to perform a task are presented. In embodiments, a high-level policy may be used to generate a series of images of a robot performing a task. Each image of the robot performing different steps of the task may comprise a subgoal of the task to be performed. A low-level policy may then be used to generate a series of control actions (e.g., actuation of motors or other robot elements) to cause a robot to perform the subgoals and ultimately perform the task by imitating the actions of the robot in the generated images.

However, some of the subgoals generated by the high-level policy may not be the most desirable actions for achieving the task. As such, in embodiments disclosed herein, the subgoals generated by the high-level policy may be filtered to remove subgoals that are physically inconsistent with the commanded language instructions. The filtered subgoals may then be presented to the low-level policy. As such, the low-level policy may receive a more accurate series of subgoals to be perform to achieve the specified task, thereby improving the functioning of the robot when implementing the low-level policy. In addition, the data input to the low-level policy may be augmented, as disclosed herein. This may make the low-level policy more robust to hallucinated artifacts that may be generated by the high-level policy in the subgoals.

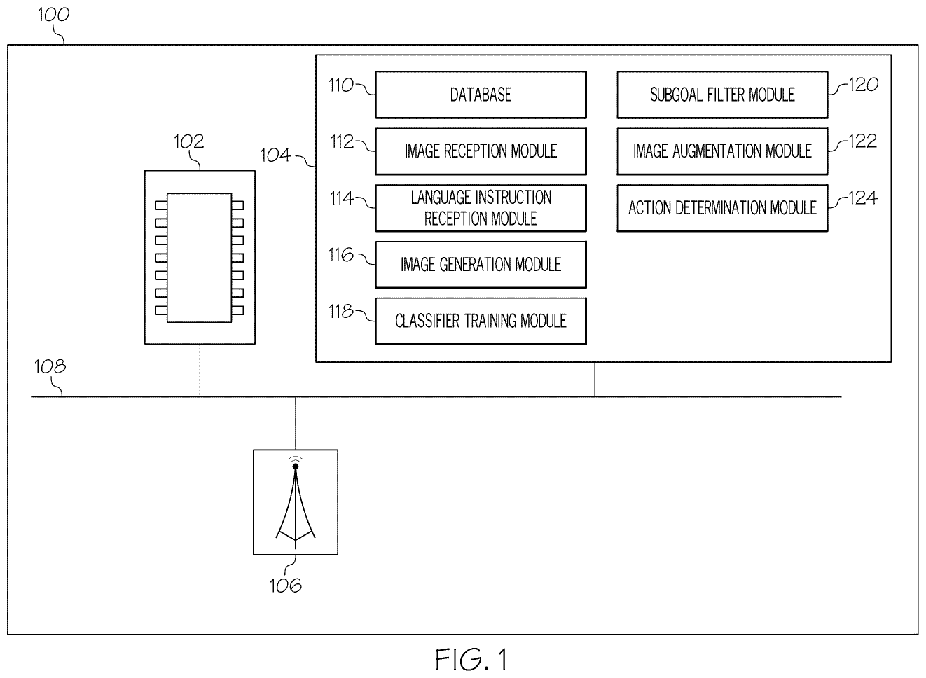

Turning now to the figures, FIG. 1 schematically depicts a computing device 100 for generating datasets for hierarchical imitation learning. The computing device 100 of FIG. 1 may comprise a local computing device, a cloud computing device, a dedicated hardware device, or any suitable device capable of performing the functions described herein.

In the example of FIG. 1, the computing device 100 comprises one or more processors 102, one or more memory modules 104, network interface hardware 106, and a communication path 108. The one or more processors 102 may be a controller, an integrated circuit, a microchip, a computer, or any other computing device. The one or more memory modules 104 may comprise RAM, ROM, flash memories, hard drives, or any device capable of storing machine readable and executable instructions such that the machine readable and executable instructions can be accessed by the one or more processors 102.

The network interface hardware 106 can be communicatively coupled to the communication path 108 and can be any device capable of transmitting and/or receiving data via a network. Accordingly, the network interface hardware 106 can include a communication transceiver for sending and/or receiving any wired or wireless communication. For example, the network interface hardware 106 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 106 includes hardware configured to operate in accordance with the Bluetooth® wireless communication protocol. The network interface hardware 106 of the computing device 100 may transmit and receive data to and from other devices.

The one or more memory modules 104 include a database 110, an image reception module 112, a language instruction reception module 114, an image generation module 116, a classifier training module 118, a subgoal filter module 120, an image augmentation module 122, and an action determination module 124. Each of the database 110, the image reception module 112, the language instruction reception module 114, the image generation module 116, the classifier training module 118, the subgoal filter module 120, the image augmentation module 122, and the action determination module 124 may be a program module in the form of operating systems, application program modules, and other program modules stored in the one or more memory modules 104. In some embodiments, the program module may be stored in a remote storage device that may communicate with the computing device 100. Such a program module may include, but is not limited to, routines, subroutines, programs, objects, components, data structures and the like for performing specific tasks or executing specific data types as will be described below.

The database 110 may store data received by the computing device 100. For example, the database 110 may store parameters associated with the models for determining the high-level policy and low-level policy, as disclosed herein. The database 110 may store images generated by the high-level policy and actions generated by the low-level policy. The database 110 may store training data to train a classifier, as disclosed herein. The database 110 may also store other data used by the various memory modules 204.

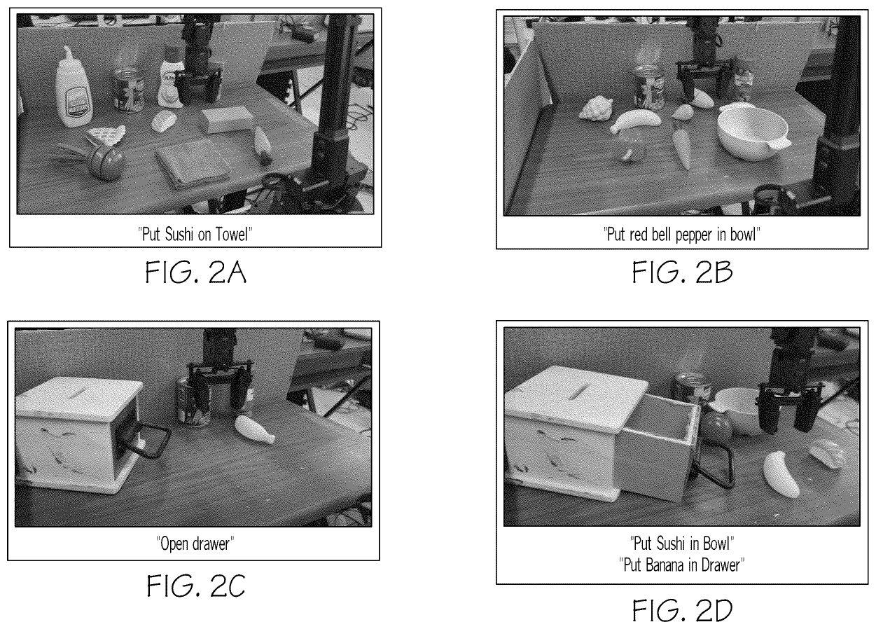

The image reception module 112 may receive images for conditioning language instruction. As discussed above, a high-level policy may take, as input, an initial image and a natural language instruction. In particular, the high-level policy may receive an initial image of a robot and a language instruction comprising a task to be performed by the robot. For example, FIGS. 2A-2D show images of a robot arm in various scenes along with a natural language instructions. In FIG. 2A, the language instruction is “Put sushi on towel”. In FIG. 2B, the language instruction is “Put red bell pepper in bowl”. In FIG. 2C, the language instruction is “Open drawer”. In FIG. 2D, the language instruction is “Put sushi in bowl” and “Put banana in drawer”.

As discussed above, the computing device 100 may implement a high-level policy to generate a series of images implementing the language instruction conditioned on the initial image. For instance, in the example of FIG. 2A, the high-level policy may generate a series of images showing the robot arm putting the sushi on the towel. Accordingly, the image reception module 112 may receive an initial image associated with a task to be performed. The image received by the image reception module 112 may be specified by a user. In particular, a user may specify a task to be learned by a robot, and may capture an image of a robot in an initial state from which the task is to be performed. This image of the initial state of the robot may be transmitted to the image reception module 112.

Referring back to FIG. 1, the language instruction reception module 114 may receive a language instruction comprising a task to be performed. FIGS. 2A-2D illustrate example language instructions that may be received by the language instruction reception module 114. The language instruction may be specified by a user. In particular, a user may specify a language instruction corresponding to a task that is to be taught to a robot. For example, if a user wishes to train a robot to put sushi on a towel, the user may provide an image that includes a robot, sushi, and a towel, as shown in the example of FIG. 2A, along with the language instruction “Put sushi on towel”. The language instruction specified by the user may be received by the language instruction reception module 114.

Referring back to FIG. 1, the image generation module 116 may generate a series of images based on the image received by the image reception module 112 and the language instruction received by the language instruction reception module 114. This may comprise the high-level policy discussed above. In particular, the image generation module 116 may utilize a pre-trained video prediction model to generate a series of predicted future images based on the received image and language instruction. That is, the image generation module 116 may predict future images based on the initial image received and the language instruction. As such, if the initial image includes a scene with a robot and the language instruction comprises an action for the robot to perform, the image generation module 116 may generate a video or series of images predicting how the robot may perform the action.

The image generation module 116 may generate the series of images using known techniques, for example, using a diffusion model. For example, the image generation module 116 may be a transformer based diffusion model trained on a large set of language conditioned images and/or video. In the example of FIG. 2A, for the language instruction “Put sushi on towel”, the image generation module 116 may generate a video or series of images showing the robot putting the sushi on the towel.

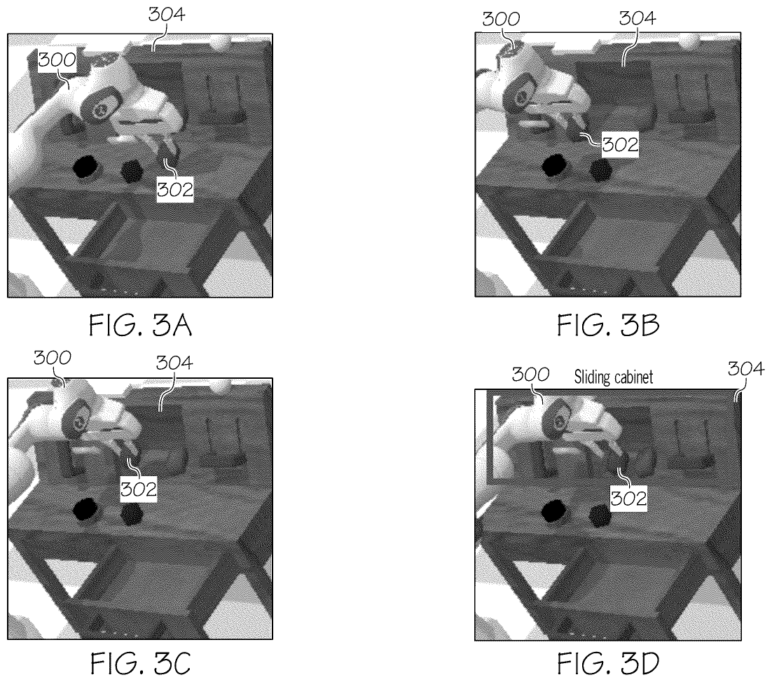

FIGS. 3A-3D show example images that may be generated by the image generation module 116. FIG. 3A shows an initial image that may be received by the image reception module 112. The image of FIG. 3A includes a robot 300, a block 302 being grasped by the robot 300, and a sliding cabinet 304. In the example of FIG. 3A, the language instruction reception module 114 may receive the language instruction “Store the grasped block in the sliding cabinet”. The image generation module 116 may then generate the images shown in FIGS. 3B-3D.

The image of FIG. 3B shows the robot 300 moving the block 302 towards the sliding cabinet 304. The image of FIG. 3C shows the robot 300 moving the block 302 even closer to the sliding cabinet 304. The image of FIG. 3D shows the robot 300 moving the block 302 into the sliding cabinet 304. The images of FIGS. 3B-3D may be used as subgoals toward the specified task of storing the grasped block in the sliding cabinet 304.

In embodiments, the image generation module 116 may generate a plurality of possible images or subgoals toward the specified task. That is, the image generation module 116 may generate multiple potential image sequences for performing the specified tasks. As such, multiple potential subgoals may be sampled, and the best subgoals may be selected, as discussed in further detail below.

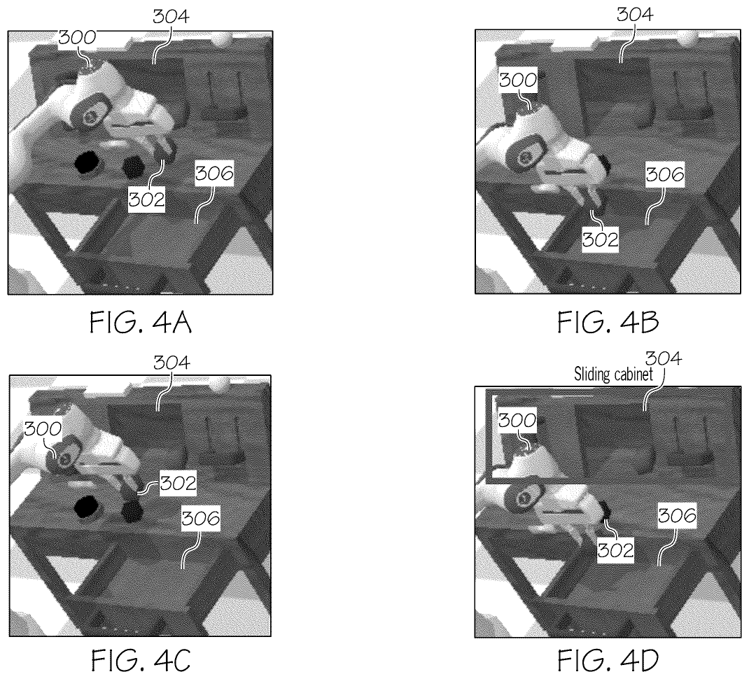

Referring back to FIG. 1, the classifier training module 118 may train a classifier to filter subgoals determined by the image generation module 116, as disclosed herein. As discussed above, the image generation module 116 may generate a series of images or subgoals indicating different steps of a robot performing a specified task. However, not all of the subgoal images may be consistent with the specified task. For example, FIGS. 4A-4D show a series of images that may be generated by the image generation module 116 when the language instruction reception module 114 receives the language instruction “Store the grasped block in the sliding cabinet”. As shown in FIGS. 4A-4D, the robot 300 moves the block 302 back and forth over a drawer 306 rather than towards the sliding cabinet 304. While the generated images may eventually show the robot 300 placing the block 302 in the sliding cabinet 304, the intermediate subgoals of FIGS. 4B-4D are not helpful towards this goal. As such, as disclosed herein, the classifier training module 118 may train a classifier to identify such unhelpful subgoals such that they can be filtered out and not presented to the low-level policy.

In embodiments, a language associated with a task (e.g., language instructions received by the language instruction reception module 114) may be represented as l. An action performed by a robot may be represented as a. Three different datasets may be used by the classifier training module 118. These three datasets are: (1) language-labeled video clips Dₗ, which contain no robot actions; (2) language-labeled robot data D_{l,a}, which includes both language labels and robot actions; and (3) un-labeled robot data that only includes actions Da. The dataset D_{l,a} comprises a set of trajectory and task language pairs,

$${\{ ( {τ}^{n} , {l}^{n} ) \}}_{n = 1}^{N} ,$$

where a trajectory contains a sequence of state,

$${s}_{t}^{n} ∈ S ,$$

and action,

$${a}_{t}^{n}$$

∈A, pairs,

$${τ}^{n} = ( {s}_{0}^{n} , {a}_{0}^{n} , {s}_{1}^{n} , {a}_{1}^{n} , ⋯ ) .$$

The subgoals generated by the image generation module 116 may be represented as g.

In embodiments, the classifier training module 118 may train a classifier f_{θ}(s, g, l) on Dₗ^{a} that predicts the probability that a transition between a current state s and the next subgoal g makes progress towards completing language instruction l. The classifier training module 118 may train the classifier in a contrastive manner by inputting a plurality of positive training examples and a plurality of negative training examples. The positive training examples may be sampled from the set of trajectories that successfully complete the language instruction l. In particular, state-goal pairs may be sampled throughout a trajectory. As such, each positive training example may comprise a state s and a goal g, where the goal g is an image that makes progress towards completing the language instruction l from the state s. This may allow the classifier to be trained to identify beneficial subgoals at any point in time during the performance of a task by the robot.

The negative training examples may be sampled in three different ways. A first type of negative example may be a wrong instruction (s, g, l′) where l′ is sampled from a different transition than s and g. A second type of negative example may be a wrong goal image (s, g′, l) where g′ is sampled from a different transition than s and l. A third type of negative example may be a reverse direction (g, s, l) where the order of the current image observation and the subgoal image have been reversed. As such, each negative training example may comprise a state s and a goal g, where the goal g is an image that does not make progress towards the language instruction l from the state s. The use of both positive training examples and negative training examples can help the classifier to identify whether a candidate goal image is making temporal progress towards completing the language instruction.

After receiving the positive training examples and the negative training examples, the classifier training module 118 may train the classifier in a contrastive manner based on the training examples. In one example, the classifier training module 118 may train the classifier using binary cross-entropy loss. In particular, the classifier training module 118 may train the classifier to receive an input state s, a subgoal state g, and a language instruction l, and to output a probability that the transition between the state s and the subgoal g makes progress towards completing the language instruction l. After training, the parameters of the trained classifier may be stored in the database 110.

Referring back to FIG. 1, the subgoal filter module 120 may filter subgoals generated by the image generation module 116, as disclosed herein. In particular, the image generation module 116 may generate a plurality of image streams of a robot performing a specified task comprising a plurality of potential subgoals, as discussed above. The image generation module 116 may generate the images in a partially random process (e.g., using diffusion), such that each time the image generation module 116 generates images of a robot performing a task, a different set of images may be generated, even from the same initial image and the same language instruction. As such, the image generation module 116 may generate a plurality of different subgoals for a particular initial image and specified task.

The plurality of potential subgoals generated by the image generation module 116 for a specified language instruction/may be input into the trained classifier. The classifier may output a probability that each potential subgoal makes progress towards completing the language instruction l. The subgoal filter module 120 may then select the subgoal with the highest progress probability. Accordingly, the best set of images of the robot performing the specified task may be selected by the subgoal filter module 120.

Referring still to FIG. 1, the image augmentation module 122 may augment images selected by the subgoal filter module 120, as disclosed herein. When the image generation module 116 generates images of the robot performing a selected task, some of the generated images may have hallucinated artifacts, which can be challenging for both the subgoal filter module 120 and the low-level policy to adapt to. For example, the image generation module 116 may generate incorrect features, change colors, add objects, distort objects, and the like. As such, in some examples, the image augmentation module 122 may augment one or more of the images generated by the image generation module 116 before the generated images are used by the classifier training module 118 to train the classifier. As such, the trained classifier may be more robust to errors or hallucinated artifacts generated by the image generation module 116. In some examples, the image augmentation module 122 may also augment images used to train the low-level policy.

In embodiments, the image augmentation module 122 may augment images in a variety of ways such as random cropping or color jittering of images. This may improve the robustness of the trained classifier to distribution shifts between the training and evaluation domains. Furthermore, as discussed above, the classifier training module 118 is trained using training examples comprising state-goal pairs. In particular, each training example includes a state s and a goal g. In some examples, augmentation parameters may be sampled and applied to both the state s and the goal g in a training example. However, to encourage robustness to errors or artifacts generated by the image generation module 116, different augmentation parameters may be used for the state s and the goal g.

In particular, for a given training example generated by the image generation module 116, the image augmentation module 122 may sample one set of augmentation parameters to apply to the state s, and a second set of augmentation parameters to apply to the goal g. The augmentation parameters may be randomly sampled from a space of potential augmentation parameters. The potential augmentation parameters may comprise cropping an image, resizing an image, changing image brightness, changing image contrast, changing image saturation, changing image hue, and the like. The augmentation performed by the image augmentation module 122 may comprise performing one or more of these augmentations in a random manner. Thus, by sampling different augmentation parameters to be applied to the state s and the goal g, the state s and the goal g may be augmented in different ways. These augmented images may then be used to train the classifier and/or the low-level policy, thereby forcing them to be robust to artifacts in the images generated by the image generation module 116.

Referring back to FIG. 1, the action determination module 124 may implement the low-level policy, as disclosed herein. In particular, the action determination module 124 may receive the series of images selected by the subgoal filter module 120 showing a robot performing a specified task, and determine control actions to be performed by an actual robot to mimic the robot in the images. In embodiments, the action determination module 124 may be trained to receive a series of images of a robot performing a task, and determine control actions to be implemented by an actual robot to perform the action in real-life by mimicking the actions of the robot in the images. The control actions may comprise control of various actuators, motors, or other components of the robot. As such, the action determination module 124 may implement the low-level policy to generate actions to be performed by an actual robot to perform a task based on the images of a robot performing the task generated by the high-level policy.

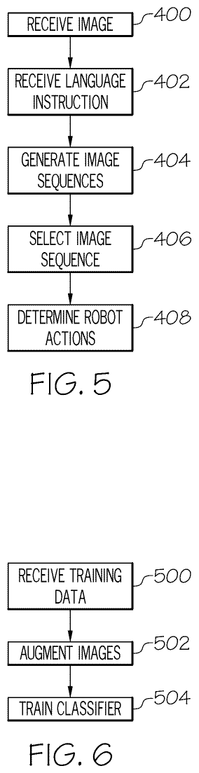

FIG. 5 depicts a flowchart of an example method of operating the computing device 100. At step 400, the image reception module 112 receives an image of a robot. At step 402, the language instruction reception module 114 receives a language instruction of a task to be performed by the robot.

At step 404, the image generation module 116 generates a plurality of image sequences of the robot performing the task specified in the language instruction based on the received image. Each image sequence generated by the image generation module 116 may be distinct, and generated using random processes. In some examples, the image generation module 116 may generate the image sequences using a diffusion model, as disclosed above.

At step 406, the subgoal filter module 120 selects one of the image sequences from among the plurality of image sequences generated by the image generation module 116 having the highest probability of successfully performing the task. In particular, the subgoal filter module 120 may select the best image sequence using a trained classifier, as discussed above. At step 408, the action determination module 124 determine robot actions to be performed by a robot to perform the task by mimicking the actions of the robot in the selected image sequence.

FIG. 6 depicts a flowchart of an example method of training the classifier maintained by the computing device 100 to select the best image sequence among the plurality of images sequences generated by the image generation module 116. At step 500, the classifier training module 118 receives training data to be used to train the classifier. In particular, the classifier training module 118 may receive a plurality of positive training examples and a plurality of negative training examples, as discussed above. Each training example may comprise an image of a current state, an image of a goal state, and a language instruction. The language instruction may comprise a task to be performed by the robot in the current state.

At step 502, the image augmentation module 122 augments the images of the current state and the images of the goal state in the training examples. In particular, for each training example, the image augmentation module 122 may augment the image of the current state and the image of the goal state in a different manner. As discussed above, this may make the trained classifier more robust to errors or artifacts in the images generated by the image generation module 116. The image augmentation module 122 may augment the images in the positive training examples and the images in the negative training examples.

At step 504, the classifier training module 118 trains the classifier in a contrastive manner based on the augmented positive examples and the augmented negative examples.

It should now be understood that embodiments described herein are directed to a method and system for performing hierarchical imitation learning to train a robot to perform a task. By using a classifier to select the best image sequence from a plurality of generated image sequences in the high-level policy, better images can be presented to the low-level policy, thereby improving the ability of the low-level policy to implement low-level policy based on the images. Furthermore, augmenting the training data used to train the classifier, the classifier can be trained to more accurately select the best images to be passed on the low-level policy. In particular, by augmenting a current state and a goal state of the training examples in different manners, the classifier can be trained to be more robust to variations in the images generated by the high-level policy.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving an image of a robot;
receiving a language instruction of a task to be performed by the robot;
generating a plurality of image sequences of the robot performing the task based on the received image of the robot and the language instruction;
selecting a first image sequence among the plurality of image sequences having a highest probability of performing the task; and
determining a plurality of actions to be performed by a second robot to perform the task based on the first image sequence.

2. The method of claim 1, further comprising generating the plurality of image sequences using a diffusion model.

3. The method of claim 1, further comprising selecting the first image sequence using a classifier that has been trained to receive a first image comprising a current state of the robot, a second image comprising a goal state of the robot, and the language instruction, and output a probability that a transition between the current state and the goal state makes progress towards completing the task.

4. The method of claim 3, further comprising training the classifier in a contrastive manner using a plurality of positive training examples and a plurality of negative training examples, wherein each of the positive training examples and the negative training examples comprises an image of a current state, an image of a goal state, and a language instruction.

5. The method of claim 4, wherein each of the positive training examples comprises an image of a current state, an image of a goal state, and a language instruction sampled from a dataset of images of a robot performing language-labeled tasks.

6. The method of claim 4, wherein each of the negative examples comprises an image of a current state, an image of a goal state, and a language instruction sampled from a dataset of images of a robot performing language-labeled tasks, wherein the language instruction is sampled from a different transition than the current state and the goal state.

7. The method of claim 4, wherein each of the negative examples comprises an image of a current state, an image of a goal state, and a language instruction sampled from a dataset of images of a robot performing language-labeled tasks, wherein the goal state is sampled from a different transition than the current state and the language instruction.

8. The method of claim 4, wherein each of the negative examples comprises an image of a current state, an image of a goal state, and a language instruction sampled from a dataset of images of a robot performing language-labeled tasks, wherein the current state and the goal state have been switched.

9. The method of claim 4, further comprising augmenting the image of the current state and the image of the goal state for one or more of the positive training examples and the negative training examples.

10. The method of claim 9, further comprising augmenting the image of the current state in a different manner than the image of the image of the goal state.

11. The method of claim 9, further comprising augmenting the image of the current state and the image of the goal state by randomly varying one or more of cropping of the images, sizing of the images, brightness of the images, contrast of the images, saturation of the images, or hue of the images.

12. A computing device comprising one or more processors configured to:
receive an image of a robot;
receive a language instruction of a task to be performed by the robot;
generate a plurality of image sequences of the robot performing the task based on the received image of the robot and the language instruction;
select a first image sequence among the plurality of image sequences having a highest probability of performing the task; and
determine a plurality of actions to be performed by a second robot to perform the task based on the first image sequence.

13. The computing device of claim 12, wherein the one or processors are further configured to select the first image sequence using a classifier that has been trained to receive a first image comprising a current state of the robot, a second image comprising a goal state of the robot, and the language instruction, and output a probability that a transition between the current state and the goal state makes progress towards completing the task.

14. The computing device of claim 13, wherein the one or more processors are further configured to train the classifier in a contrastive manner using a plurality of positive training examples and a plurality of negative training examples, wherein each of the positive training examples and the negative training examples comprises an image of a current state, an image of a goal state, and a language instruction.

15. The computing device of claim 14, wherein each of the positive training examples comprises an image of a current state, an image of a goal state, and a language instruction sampled from a dataset of images of a robot performing language-labeled tasks.

16. The computing device of claim 14, wherein each of the negative examples comprises an image of a current state, an image of a goal state, and a language instruction sampled from a dataset of images of a robot performing language-labeled tasks, wherein the language instruction is sampled from a different transition than the current state and the goal state.

17. The computing device of claim 14, wherein each of the negative examples comprises an image of a current state, an image of a goal state, and a language instruction sampled from a dataset of images of a robot performing language-labeled tasks, wherein the goal state is sampled from a different transition than the current state and the language instruction.

18. The computing device of claim 14, wherein each of the negative examples comprises an image of a current state, an image of a goal state, and a language instruction sampled from a dataset of images of a robot performing language-labeled tasks, wherein the current state and the goal state have been switched.

19. The computing device of claim 14, wherein the one or more processors are further configured to augment the image of the current state in a first manner and augment the image of the goal state in a second manner for one or more of the positive training examples and the negative training examples.

20. The computing device of claim 19, wherein the one or more processors are further configured to augment the image of the current state and the image of the goal state by randomly varying one or more of cropping of the images, sizing of the images, brightness of the images, contrast of the images, saturation of the images, or hue of the images.
